(19) United States
(12) Patent Application Publication
(10) Pub. No.: US 2020/0361417 A1
(43) Pub. Date: Nov. 19, 2020

(54) Windshield Cleaning Appliance and Cleaner Composition

(71) Applicants: Dennis Willard Davis, Palm Bay, FL (US); James Grant Wallin, Terra Ceia, FL (US)

(72) Inventors: Dennis Willard Davis, Palm Bay, FL (US); James Grant Wallin, Terra Ceia, FL (US)

(21) Appl. No.: 16/872,682

(22) Filed: May 12, 2020

Related U.S. Application Data
(60) Provisional application No. 62/920,738, filed on May 13, 2019.

(51) Int. Cl. B60S 1/04; C11D 1/62; C11D 1/82

(52) U.S. Cl. CPC B60S 1/0491; C11D 1/82; C11D 1/62

(57) ABSTRACT

Presently disclosed is a disposable windshield wiper blade attachment that incorporates chemicals that will expedite insect and other debris removal when attached to the wiper blades and the wiper action is performed. In a preferred embodiment, the attachment takes the form of fabric, foam, or other porous enclosure of synthetic or natural material that is impregnated with chemicals that will facilitate rapid removal of the windshield debris.

### CROSS-REFERENCE TO RELATED APPLICATIONS

This application claims the benefit of U.S. provisional application Patent Application Ser. No. 62/920,738 filed May 13, 2019 for “Windshield Cleaning Appliance” by Dennis W. Davis and James G. Wallin.

### BACKGROUND

Motorized vehicles of all kinds, including cars, trucks, recreational vehicles, heavy equipment vehicles, buses, boats, and private aircraft, are invariably impacted by insects colliding with the vehicle windshield. The resulting insect residue on windshields can be messy and especially difficult to remove if the insect debris has become desiccated.

The windshields of moving vehicles encounter many different species of insects, but larger numbers are associated with particular ones including mayflies of the northern US, midges or small flies (including aquatic midges known as blind mosquitos and no-see-ums) and mosquitoes found throughout the US. Particularly bothersome is the love bug (Plecia nearctica), a species of March fly found in the southeastern United States, especially along the Gulf Coast.

Often, the insect debris is of sufficient volume that the windshield and wiper blades need to be toweled in addition to using wiper motion with dispensed wiper fluid. Quite often, wipers will simply smear the insect debris across the windshield. In the event the wiper fluid is depleted, things are even more difficult. When remote from a gas station there is the inconvenience of the need to locate a source of water for cleaning the windshield. Methyl alcohol (the chief ingredient of wiper fluid) alone, often is ineffective in removing tenacious desiccated insect and other debris from windshields.

### PRIOR ART

To date, methods to address difficult-to-remove windshield dirt comprise use of windshield wiper fluid, dispensed while operating windshield wipers (this often smears the dirt deposits), and Ice scrapers and squeegees, which usually must be used in concert with paper towels or rags.

US patent application number 2004/0156991 to Brown et al. discloses a dispenser that is attached to or made part of a wiper blade that dispenses hydrophobic or hydrophilic surface treatment material to the windshield for either repelling water or wetting the windshield, respectively. This involves a modification of the actual wiper blade that could accumulate debris.

The product called Scrubberblade (https://gadgetsgo.com/scrubbing-wind-shield-wipers.html) comprises a wiper double blade design that exhibits small protuberances on the blades. Even this improved wiper blade design will have trouble with desiccated debris.

U.S. Pat. No. 6,687,946 discloses a wiper blade attachment with pressurized inflatable scrubbing member. The device is pressurized by windshield wiper fluid and permits seepage of fluid onto the windshield. This is a semi-permanent attachment and is not disposable.

US patent application number 20130000802 provides an example of coverings for windshield wiper blades designed to impede ice formation on the blades. Other such covers are for the purpose of preventing ultraviolet light damage to the blade rubber.

It would be advantageous to have a mechanism that uses the windshield wipers for efficient insect debris removal that a) does not involve modification of the wiper blade, ie. adhoc modification of the existing wiper or replacement with blades of a different design, b) minimizes the user's exposure to the dirt and debris to be removed, and c) is disposable.

### SUMMARY OF THE INVENTION

Presently disclosed is a disposable windshield wiper blade attachment that incorporates chemicals that will expedite insect and other debris removal when attached to the wiper blades and the wiper action is performed. In a preferred embodiment, the attachment takes the form of fabric, foam, or other porous enclosure of synthetic or natural material that is impregnated with chemicals that will facilitate rapid removal of the windshield debris.

### DESCRIPTION OF THE DRAWINGS

FIG. 1 is a pictorial diagram of a windshield wiper blade assembly and arm.

FIG. 2A is a pictorial diagram of a windshield wiper blade assembly and arm highlighting the angle between the arm and the blade assembly.

FIG. 2B is a pictorial diagram of a windshield cleaning wiper attachment that exhibits clamping tension and a slot for installation and removal.

FIG. 2C is a pictorial diagram of the windshield cleaning wiper attachment of FIG. 2B installed on a windshield wiper blade assembly.

FIG. 3A is a pictorial diagram of a windshield cleaning wiper attachment that is attached to the wiper assembly by tabs.

FIG. 3B is a pictorial diagram of a windshield cleaning wiper attachment that is attached to the wiper assembly by affixing strips.

FIG. 4A is a pictorial diagram of a windshield cleaning wiper attachment that comprises a bag geometry enclosing the windshield wiper blade assembly and a portion of the arm.

FIG. 4B is a pictorial diagram of a windshield cleaning wiper attachment that comprises a bag geometry enclosing the windshield wiper blade assembly the exhibits a pleated region in the area of the arm attachment to the wiper blade assembly.

FIG. 4C is a pictorial diagram of a windshield cleaning wiper attachment that comprises a dual bag geometry with one bag end overlapping and closing upon the other bag end.

FIG. 5A is a pictorial diagram of a windshield wiper blade assembly and arm characteristic of trucks and other vehicles in which the angle between the arm and the blade assembly remains relatively constant.

FIG. 5B is a pictorial diagram of a windshield cleaning wiper attachment adapted to the windshield wiper blade assembly and arm of FIG. 5A comprising and enclosure of both the windshield wiper blade assembly and a portion of the arm.

### DETAILED DESCRIPTION OF THE INVENTION

A disposable sleeve or enclosure for removable application to windshield wipers that contains chemicals that expedite the removal of dried material from windshields such as insect debris, especially dried insect debris is disclosed below.

Debris Removal Chemistry

There are a number of chemical compounds and mixtures that can be used in the present invention and are within the scope of this disclosure. Among them are methyl alcohol, petroleum distillates, ethylene glycol mono butyl ether, other degreasers, Mr. Clean Magic Eraser, WD-40, and Avon Skin-So-Soft. Additionally, it has been found that dampened laundry dryer sheets are exceedingly efficient at removing dried insect debris from automobiles without the need for scrubbing. In a preferred embodiment, a device is disclosed which permits application of such chemicals to the windshield by windshield wipers.

Fabric conditioning agents within dryer sheets are transferred to laundry to impart fabric softening or other conditioning properties; they exhibit surfactant properties useful in the present invention. Typical compounds impregnated in dryer sheers are disclosed in U.S. Pat. No. 7,943,566 to Uitenbroek et al. and U.S. Pat. No. 5,080,810A to Smith et al, which disclose methods of manufacturing dryer sheets and are incorporated herein by reference thereto. Among such agents including surfactants found in dryer sheets, are silicone oils or tallow or vegetable-based quaternary ammonium compounds, these include alkylated quaternary ammonium compounds, ring or cyclic quaternary ammonium compounds, aromatic quaternary ammonium compounds, diquaternary ammonium compounds, amidoamine quaternary ammonium compounds, ester quaternary ammonium compounds, and mixtures of these. The categories of surfactants delineated in UK patent application number GB2185752A are hereby incorporated by reference thereto. These and other compounds that can promote efficient removal of insect and other debris from windshields are within the scope of the present invention.

For the purposes of the present invention, other chemicals found in dryer sheets that have been identified as potential carcinogens, hazardous pollutants, or endocrine disruptors are unnecessary.

### Embodiments

Various embodiments of the present invention are herein disclosed. All are a form of impregnated material removably attachable to windshield wiper blades or blade assemblies. The wide variety of feasible shapes for the removably attachable device are within the scope of the presently disclosed concept. Accommodation must be made for the variation in wiper blade sizes from vehicle to vehicle and, as described below, for embodiments that work with dynamic changes in wiper blade assembly geometry. These embodiments emphasize avoidance of hand contact with dirt, ease of application, and ease of disposal.

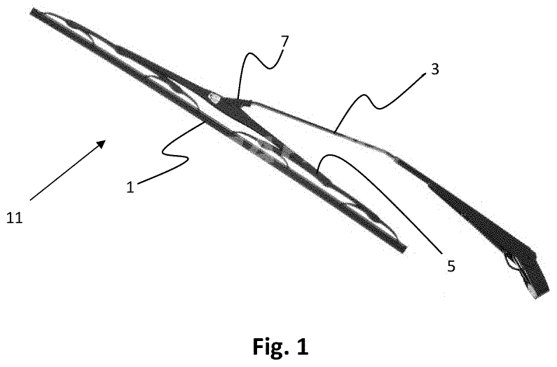

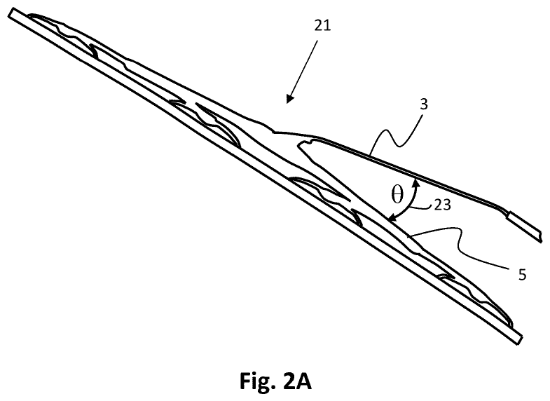

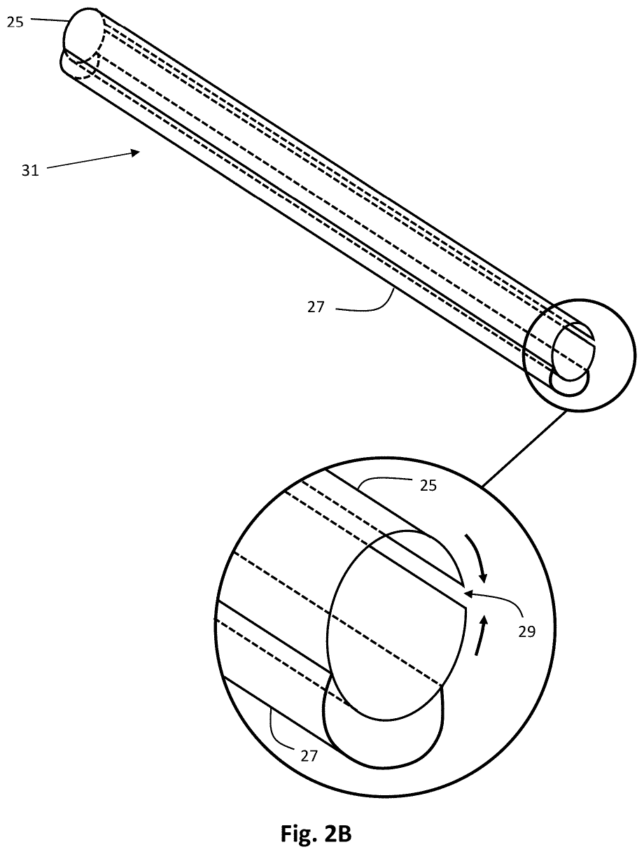

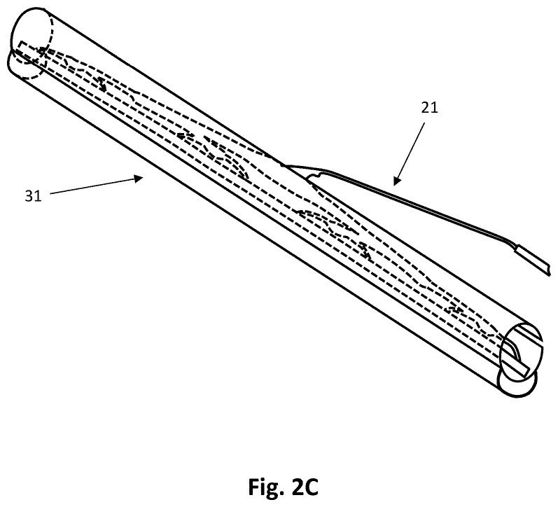

Reference is made to FIG. 1 which depicts the basic geometry 11 of the typical automobile windshield wiper system. The wiper blade 1 is held by the wiper blade assembly 5 that is mounted to the wiper arm 3 by articulating connection 7. FIG. 2A emphasizes the variation in angle 23 that can occur between the arm 3 and the wiper assembly 5 during wiper motion. For selected embodiments of the presently disclosed concept, angle variation must be accommodated. FIG. 2B depicts a first embodiment of a windshield cleaning attachment 31 comprising a stiff, but not rigid, cylinder 25 that exhibits a longitudinal slot 29. The cylinder 25 is constructed from a plastic or other material that demonstrates adequate closure tension for mounting on the wiper blade assembly. The slot edges of the cylinder are spread apart for installation on the wiper blade assembly. Attached to the stiff cylinder 25 is a pliable chemical containing pad 27 that is located at a circumferential position along the length of the cylinder that permits it to make contact with the windshield after it is installed on the wiper blade assembly as shown in FIG. 2C. Various cleaning chemicals previously discussed are candidates for impregnation of the pad 27. The cylinder 25 can be made of plastic, laminated card stock, or other semi rigid material that can be made to provide closure tension. The pad 27 can be made from natural or synthetic fabric, foam, or other porous material with volume enough to contain adequate cleaning chemical.

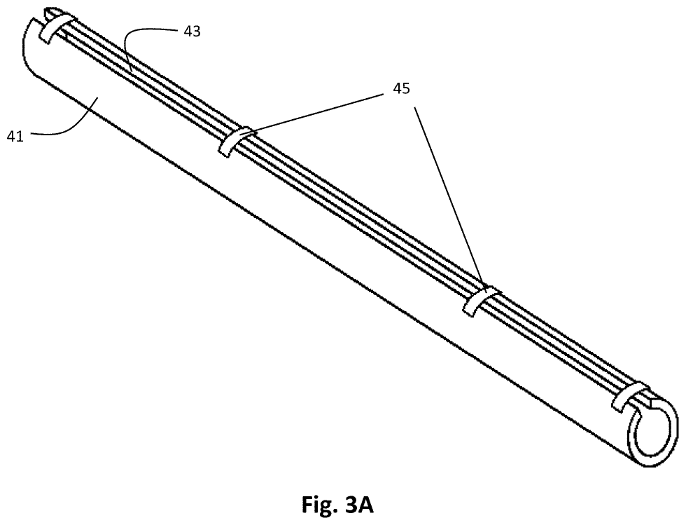

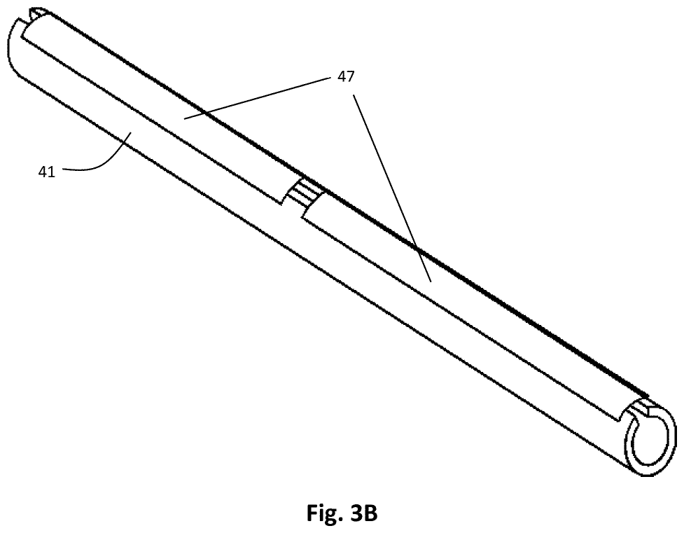

FIG. 3A depicts a cleaning chemical impregnated pad 41 that when mounted on the wiper blade assembly encloses it and demonstrates closure tabs 45 across the opening 43 created by the pad edges. The tabs can be Velcro™ or adhesive-based fasteners. In FIG. 3B, closure strips 47 are shown substituted for tabs. Alternatively, the pad need not enclose the wiper blade assembly, but simply attach to the region of the blade that makes windshield contact.

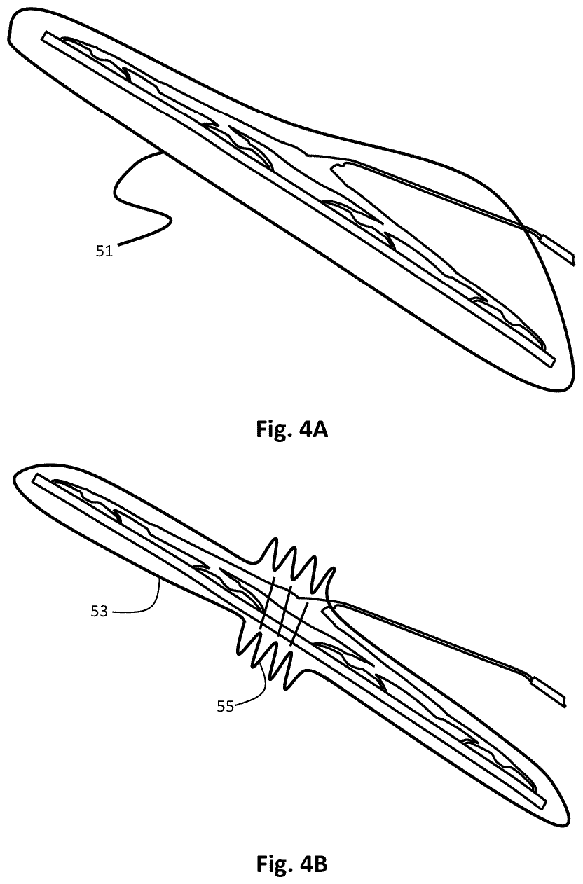

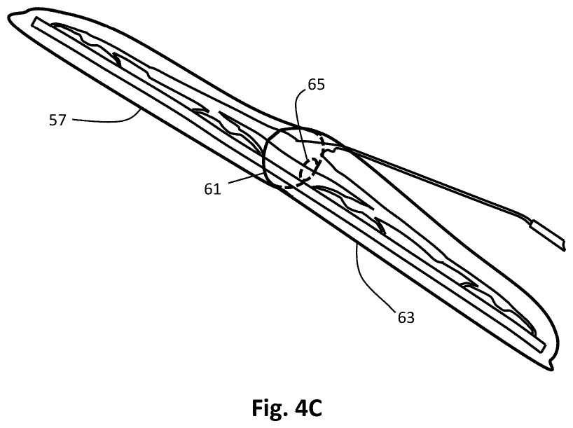

Bag geometries of the invention are shown in FIGS. 4A, B, and C. FIG. 4A depicts a bag or sleeve that encloses both wiper blade assembly and arm and accommodates the change in angle between the wiper blade assembly and the arm. The bag or sleeve is impregnated with cleaning chemical and may contain a pouch volume, not shown, for sufficient dispensing of chemical. FIG. 4B depicts a bag geometry that has a pleated region 53 to accommodate wiper changes in geometry during motion. The bag can have a closure mechanism, not shown, such as a draw string, Velcro™ strip, or elastic closure. Alternatively, the bag itself can exhibit elasticity sufficient to remain affixed to the wiper assembly during wiper motion. Yet another prospect is for the bag or sleeve to be slide onto the wiper assembly and have a tear away feature for ease of removal. A dual bag geometry is shown in FIG. 4C. A first bag 57 is used to cover a portion of the wiper blade assembly and had a cinched closure 65 at one end. A second bag 63 encloses the balance of the wiper blade assembly, overlaps the first bag 57 and has a cinched closure 61 atop the first bag. Bags 57 and 61 both have a chemical dispensing volume, not shown, in contact with the windshield.

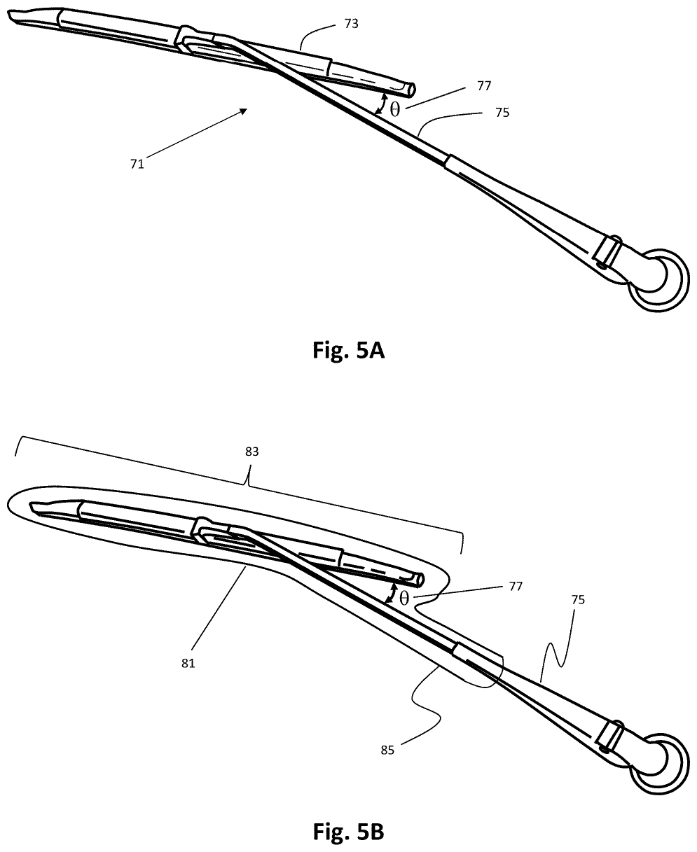

FIG. 5A depicts a wiper geometry 71 often found on trucks and other vehicles in which the angle 77 is relatively constant during wiper motion. In FIG. 5B, the bag 81 used in this instance encloses the region 83 of the wiper and region 85 of the wiper arm.

Cleaning wipes can be made from porous material impregnated with the surfactant composition for insect and debris removal.

A final implementation comprises the use of the aforementioned chemicals in a wiper fluid that would be dispensed in the same way as conventional windshield wiper fluid.

Various other embodiments of the disclosed concept not delineated, but which derive from this disclosure are deemed within the scope of the present invention.

1. A disposable wiper blade attachment for removal of difficult-to-remove windshield-adhered debris, the attachment comprising:
a. a chemically-impregnated windshield contacting element, and
b. windshield wiper attachment means,
the chemically impregnated windshield contacting element comprising a fabric or foam impregnated with compounds that are known to remove windshield debris such as desiccated insects, the chemically-impregnated windshield contacting element attachable to a windshield wiper blade assembly.

2. A disposable wiper blade attachment as recited in claim 1, wherein the composition for the chemical impregnation is taken from the group comprising:
a) vegetable-based quaternary ammonium compounds,
b) alkylated quaternary ammonium compounds,
c) ring or cyclic quaternary ammonium compounds,
d) aromatic quaternary ammonium compounds,
e) diquaternary ammonium compounds,
f) amidoamine quaternary ammonium compounds, and
g) ester quaternary ammonium compounds.

3. A disposable wiper blade attachment as recited in claim 2, wherein the composition for the chemical impregnation is taken from the additional group comprising:
a) silicone oils,
b) tallow,
c) polydimethylsiloxane,
d) methyl alcohol,
e) petroleum distillates,
f) ethylene glycol mono butyl ether,
g) other degreasers,
h) Mr. Clean Magic Eraser,
i) WD-40, and
j) Avon Skin-So-Soft.

4. A disposable wiper blade attachment as recited in claim 1 for attachment to a wiper assembly, wherein the windshield wiper attachment means comprises a flexible cylinder exhibiting a length and diameter and with a slit along its length, the cylinder exhibiting closure tension as it captivates the wiper assembly, the chemically-impregnated windshield contacting element comprises a linear foam or cloth pad affixed along the length of the flexible cylinder so as to conformally contact the windshield when the wiper blade attachment is installed on the wiper assembly.

5. A disposable wiper blade attachment as recited in claim 1 for attachment to a wiper assembly, wherein the chemically-impregnated windshield contacting element comprises a linear foam or cloth sheet and the attachment means comprises adhesive or Velcro™ straps, the cloth or foam sheet rolled around the wiper assembly and affixed to it by the attachment means.

6. A disposable wiper blade attachment as recited in claim 1 for attachment to a wiper assembly, wherein the chemically-impregnated windshield contacting element comprises a linear foam or cloth pad and the attachment means comprises adhesive or Velcro™ straps, the cloth or foam pad affixed to the wiper assembly so as to contact a windshield.

7. A disposable wiper blade attachment as recited in claim 1 an elongated bag of cloth or foam material which is chemically-impregnated and attaches to the wiper assembly by enveloping the wiper assembly and exhibits a closure mechanism.

8. A disposable wiper blade attachment as recited in claim 5 wherein the elongated bag is form-fitted to the wiper assembly and exhibits flexure bellows to accommodate wiper motion

9. A disposable wiper blade attachment as recited in claim 5 wherein the elongated bag is comprises two halves that are affixed together at the longitudinal center of the wiper assembly.

10. A disposable wiper blade attachment as recited in claim 1 for attachment to a wiper assembly and wiper arm, comprising a chemically-impregnated enclosure that encloses the wiper assembly and a portion of the wiper arm.

11. A windshield washer solution comprising compounds taken from the group comprising:
a) vegetable-based quaternary ammonium compounds,
b) alkylated quaternary ammonium compounds,
c) ring or cyclic quaternary ammonium compounds,
d) aromatic quaternary ammonium compounds,
e) diquaternary ammonium compounds,
f) amidoamine quaternary ammonium compounds, and
g) ester quaternary ammonium compounds.

12. A windshield washer solution as recited in claim 11 comprising additional compounds taken from the group comprising:
a) surfactants found in dryer sheets,
b) silicone oils or tallow or vegetable-based quaternary ammonium compounds,
c) polydimethylsiloxane,
d)alkylated quaternary ammonium compounds,
e) ring or cyclic quaternary ammonium compounds,
f) aromatic quaternary ammonium compounds,
g) diquaternary ammonium compounds,
h)amidoamine quaternary ammonium compounds,
i) ester quaternary ammonium compounds, and
j)methyl alcohol,
k) petroleum distillates,
l) ethylene glycol mono butyl ether, other degreasers,
m) Mr. Clean Magic Eraser,
n) WD-40, and
o) Avon Skin-So-Soft.
